(19) United States
(12) Patent Application Publication
(10) Pub. No.: US 2021/0108365 A1
(43) Pub. Date: Apr. 15, 2021

(54) IMITATION LEATHER VINYL, KNITS, AND OTHER WOVEN FABRICS WITH ELASTOMERIC PROPERTIES AND METHODS THEREOF

(71) Applicant: L&P PROPERTY MANAGEMENT COMPANY, South Gate, CA (US)

(72) Inventors: Rogelio Tornero, Greensboro, NC (US); Giovanni Fiorentino, SANTERAMO IN COLLE (IT)

(21) Appl. No.: 16/600,245

(22) Filed: Oct. 11, 2019

(51) Int. Cl. D06M 17/10; B32B 27/40; B32B 27/12; B32B 5/02; B32B 27/30

(52) U.S. Cl. CPC D06M 17/10; B32B 27/40; B32B 27/12; D06M 2101/32; B32B 27/304; B32B 2479/00; B32B 2437/00; B32B 5/022

(57) ABSTRACT

Methods and products are described that include an artificial leather, knit, or woven material with a high modulus of elasticity. Generally, the material is comprised of multiple layers including an outer layer and an elastomeric fabric-based support layer. The material can also include a backing layer positioned between the outer layer and the support layer.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

Embodiments of the present invention relate to artificial or synthetic leather materials, and other upholstery covers.

### BRIEF DESCRIPTION OF THE INVENTION

In a typical seating construction, upholstery materials such as leather, calendered and cast vinyls, knits, and woven fabrics are used as covers in seats, chairs, sofas, benches, transportation seating applications, etc. In order to obtain comfort, materials such as polyurethane urethane foam, polyester batting, metal springs, and elastic webbings are attached to the article frame and subsequently the cover material is installed. For example, artificial or synthetic leather products used in the textile industry are traditionally manufactured by impregnating elastomeric fabrics with urethane. The artificial leather products themselves commonly have a low modulus of elasticity (e.g., high stretch under load). While suitable for use in garments or shoes, these traditional artificial leather products are not suitable for high traffic, high-use furniture environments.

The use of elastomeric fabrics have, in some instances, replaced the abovementioned components in the furniture industry. While the use of these elastomeric fabrics are resilient, they do present some limitations. Traditionally, the elastomeric products are a see-through mesh with limited functional and aesthetic design potential and have a limited ability to incorporate desirable additives such as anti-microbials, flame retardants, and electrostatic discharge protectants.

Accordingly, methods and products are described that provide artificial leather, knit, or woven materials with a high modulus of elasticity. Advantageously, the artificial leather, knit, or woven materials can be used as a load bearing member of furniture without requiring a supporting fill. For example, the materials can be attached to one or more furniture pieces and support the weight of a person or people in excess of 100,000 times without deflection greater than 2 inches.

Generally, the artificial leather material is comprised of multiple layers of plastisol and a layer of an elastomeric fabric. The artificial leather material can also include a backing layer positioned between the plastisol and the elastomeric fabric. Similarly, methods and products are described that provide a woven or knit material with a high modulus of elasticity.

### BRIEF DESCRIPTION OF SEVERAL VIEWS OF THE DRAWINGS

The present invention is described in detail below with reference to the attached drawing figures, wherein:

FIGS. 1A and 1B are exploded views of exemplary artificial leather materials in accordance with aspects described herein;

FIG. 2 is an enlarged top-plan view of a section of an example knit elastomeric fabric in accordance with aspects described herein;

FIG. 3 is a side view of FIG. 2 along 3-3;

FIG. 4 is an enlarged top-plan view of a section of an example woven elastomeric fabric in accordance with aspects described herein;

FIG. 5 is an enlarged top-plan view of a section of another example woven elastomeric fabric in accordance with aspects described herein;

FIG. 6 is a perspective view of an example furniture item including an artificial leather material in accordance with aspects described herein; and

FIG. 7 is an example method for producing an artificial leather material in accordance with aspects described herein.

### DETAILED DESCRIPTION OF THE INVENTION

Traditional artificial leather materials have several drawbacks. As a non-exclusive example, traditional manufacturing techniques can rely on organic solvent baths to facilitate impregnating an elastomeric fabric with vinyl or polyurethane. These solvents can be difficult to properly dispose, increase waste, and increase the complexity and cost of manufacturing the artificial leather material. Additionally, traditional techniques may require post-manufacture processing including embossing and printing to impart color and texture. Again, these post-manufacture processing steps can increase the complexity and cost of producing the artificial leather.

Aspects described herein generally relate to artificial leather products having a high modulus of elasticity usable in high traffic, high use, load bearing applications, such as office or automotive seating. Additionally, the artificial leather products can be incorporated into seats or chair backs in tension framed seating. Methods for producing artificial leather materials having high modulus of elastomeric properties are also described herein.

Additionally, artificial leather materials, such as those described herein can provide a number of beneficial advantages over the natural equivalent. For example, the artificial leather materials can be tailored for the intended end-use by including antimicrobial agents, fire retardants, electrical grounding agents (i.e., materials that dissipate static electricity), and so forth.

As used herein a colorant is any pigment, dye, stain, ink, or any similar organic or inorganic compound included to intentionally alter the hue, tint, shade, tone, saturation, lightness, chroma, intensity, or other visual property of an object.

Additive refers to one, more than one, or any combination of: fire retardant compounds (such as aluminum trihydrate, magnesium hydroxide, and so forth), inorganic anti-microbial compounds (such as elemental copper, copper alloys, or cuprous/cupric compounds; elemental silver, silver alloys, or silver compounds; zinc alloys or zinc compounds), organic antimicrobial compounds (such as halogen-based organic biocides, nitrogen-based organic biocides, quaternary ammonium compounds, phenol/phenolic biocides, and so forth), scratch/mar resistant polymers (such as polypropylene) or compounds, UV protectant materials (such as oxanilides, benzophenones, benzotriazoles, hydroxyphenyltriazines, hydroxybenzophenone, hydroxyphenylbenzotriazole, TiO₂, carbon black, 2,2,6,6-tetramethylpiperidine ring containing amines, and so forth), electrostatic dispersants (such as graphite, carbon black, and so forth), or any combination thereof.

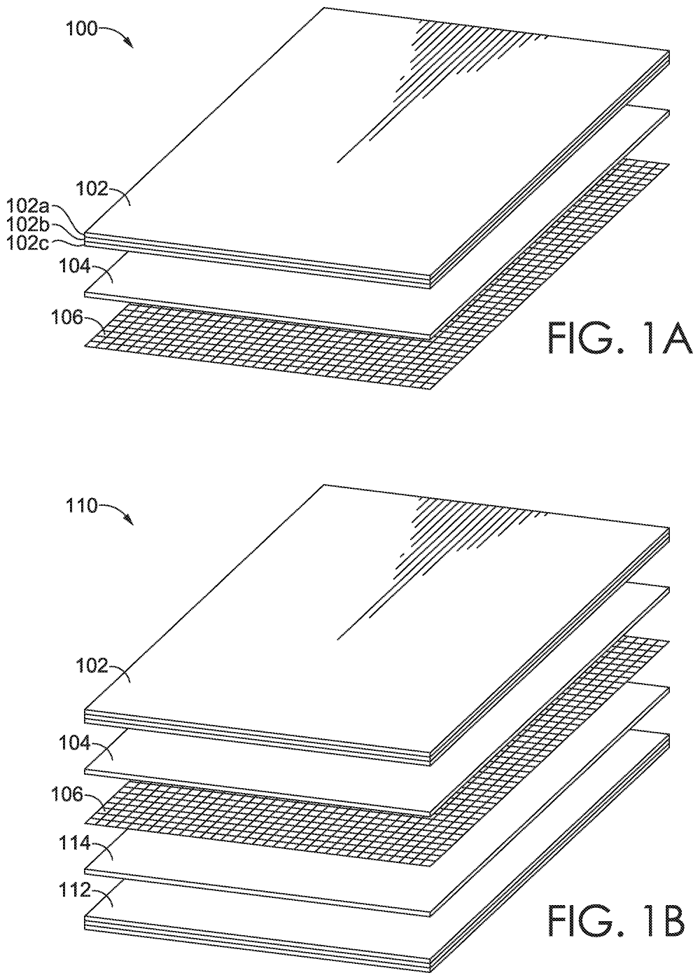

Turning now to the figures, which are not represented in scale, but rather to clearly show the various embodiments and constructions, FIG. 1A depicts a portion of an artificial leather material 100 in accordance with embodiments described herein. The artificial leather material 100 may be attached to furniture products. Such attachment can be achieved, for example, using staples, nails, bolts, screws, clamps, or any other attachment mechanisms. In this manner, artificial leather material 100 can be used as an attachment medium between two portions of a furniture product, thereby providing a secure and flexible coupling between the two portions of the furniture product. Additionally, the artificial leather material 100 can be used as a load bearing medium between two portions of a furniture product. For example, the artificial leather material 100 can be used as a seating surface between two points of a furniture product. As shown, artificial leather material 100 includes an outward facing layer 102 and an elastomeric fabric layer 106. In some aspects, artificial leather material 100 further comprises a backing layer 104.

FIG. 1B depicts a portion of an artificial leather material 110 in accordance with some embodiments described herein. The artificial leather material 110 may be attached to furniture products. Such attachment can be achieved, for example, using staples, nails, bolts, screws, clamps, or any other attachment mechanisms. In this manner, artificial leather material 110 can be used as an attachment medium between two portions of a furniture product, thereby providing a secure and flexible coupling between the two portions of the furniture product. Additionally, the artificial leather material 110 can be used as a load-bearing medium between two portions of a furniture product. For example, artificial leather material 110 can be used as a seating surface between two points of a furniture product. As shown, artificial leather material 110 includes a first outward facing layer 102, an elastomeric fabric layer 106, and a second outward facing layer 112. In some aspects, artificial leather material 110 further comprises a first backing layer 104, a second backing layer 114, or any combination thereof.

Continuing with reference to FIGS. 1A and 1B, outward facing layer 102 generally provides a smooth or textured outward surface for a furniture product. Additionally, outward facing layer 102 provides a less abrasive outer surface for artificial leather material 100, 110 or a furniture product including artificial leather material 100, 110 than traditional high modulus of elasticity fabrics used in furniture products. Similarly, the second outward facing layer 112 provides a less abrasive outer surface of an artificial leather material 100, 110 or a furniture product including artificial leather material 100, 110 than traditional high modulus of elasticity fabrics used in furniture products.

The outward facing layers 102 and 112 include two or more sublayers (collectively referred to as the outward facing layer). These sublayers generally comprise a polyurethane outermost layer 102a and one or more plastisol layers 102b, 102c. Polyurethane layer 102a generally comprises one or more thermosetting or thermoplastic polymers having at least one carbamate moiety. For example, polyurethane layer 102a can be comprised of polymers of di- or tri-isocyanates and polyols.

Additionally, in some aspects, polyurethane layer 102a includes one or more additives. The additives can be included based on the intended use case. For example, fire retardant additives can be included in some aspects of polyurethane layer 102a where artificial leather material 100, 110 or a furniture item including artificial leather material 100, 110 is potentially exposed to open flame or intense heat. Similarly, an organic antimicrobial additive, an inorganic antimicrobial additive, or a combination of both antimicrobial additives can be included in some aspects of polyurethane layer 102a where artificial leather material 100, 110 or a furniture item including artificial leather material 100, 110 is potentially exposed to infectious agents. A grounding additive can be included in some aspects of polyurethane layer 102a where artificial leather material 100, 110 or a furniture item including artificial leather material 100, 110 where the build-up or discharge of static electricity is problematic (such as a clean room).

As will be understood by those skilled in the art, many intended end use cases have multiple potential additive needs. For example, a furniture item that includes artificial leather material 100, 110 intended to be used in a hospital can include antimicrobial additives, fire retardant additives, and scratch/mar additives. Similarly, in some aspects, polyurethane layer 102a can include any combination of two or more additives.

Plastisol layers 102b and 102c are generally formed from a plasticized suspension of polyvinyl chloride (PVC), polyethylene (PE), polypropylene (PP), any combination thereof, or any other thermoplastic. In some aspects, plastisol layers 102b and 102c can include one or more additives, similar to polyurethane layer 102a.

Although described herein in relation to an artificial leather material, one skilled in the art will understand that outward facing layer 102, the second outward facing layer 112, or any combination thereof may be a woven or knit material. For example, in some aspects material 100 is comprised of an outward facing woven or knit layer 102 and an elastomeric fabric layer 106.

In some aspects, artificial leather material 100, 110 includes a backing layer 104. Backing layer 104 can be comprised of a non-woven polymeric resin. For example, backing layer 104 can be a non-woven polyester, nylon trictot scrim, or any other non-woven polymeric resin.

Elastomeric fabric layer 106 generally provides a high modulus of elasticity to artificial leather material 100, 110. Elastomeric fabric layer 106 can be a woven or knit elastomeric fabric. For example, in some aspects, elastomeric fabric layer 106 is a warp knit elastomeric fabric layer. As discussed in more detail with respect to FIG. 2, the warp knit elastomeric fabric layer 106 can include walewise parallel stich loop chains with successive courses. The walewise parallel stiches can be made with polyester warp yarns with an unknit elastomeric inlayed yarn. The polyester warp yarns can be of an about 150 denier 3 ply yarn of about 68 filament. The elastomeric inlayed yarn can be an elastomeric monofilament in the range of about 50-75 durometers and about 1800-2400 denier. In some aspects, the warp knit elastomeric fabric 106 further includes two or more weftwise fill yarns per course. The weftwise fill yarns can be about 150 denier polyester yarns. In some aspects, the warp knit elastomeric fabric 106 further includes 100 ends of about 840 denier high tenacity polypropylene yarn. The warp knit elastomeric fabric can, according to aspects, be constructed on a conventional warp-knit machine such as a Comez, which is well-known in the knitting industry.

Alternatively, in some aspects, elastomeric fabric layer 106 is a woven elastomeric fabric. For example, in some aspects, elastomeric fabric layer 106 is a plane weave or leno weave made by weaving polyester yarns with about 20-22 ends per inch. In some aspects, the polyester yarns are in the range of about 1800-2400 denier. Additionally in some aspects, the polyester yarns are in the range of about 50-75 durometers. The polyester yarns can be mono-component or bi-component yarns made with polyester monofilament strands. For example, in a particular aspect, the elastomeric fabric layer 106 is a 22 ends per inch leno weave with 2400 denier, 55 durometer, bicomponent yarns with monofilament polyester, and elastomer strands.

Turning to FIG. 2, an enlarged top-plan view of a section of warp knit elastomeric fabric 200, such as some aspects of elastomeric fabric layer 106, is depicted. Warp knit elastomeric fabric 200 includes a plurality of walewise parallel stitch-loop chains 204 that are formed utilizing stitch-loop yarn 202, as described in U.S. Pat. No. 5,522,240 to Wall et al., issued Jun. 4, 1996, which is incorporated herein by reference. In an aspect, the stitch-loop yarn 202 can be an about 150 denier, 3 ply, about 68 filament yarn. The walewise parallel stitch-loop chains 204 can be at about 12 to about 16 ends per inch.

In an aspect, a filling yarn 206 (also referred to as fill yarn 206) may be included as well. For example, in an embodiment, fill yarn 206 can be used in border segments of the artificial leather material 100, 110 to provide a stronger structure for supporting attachment to furniture products, as discussed above. Fill yarn 206 can be a 2 ply about 150 denier yarn in an aspect. The filling yarn 206 can be continuously incorporated into the knit 200. Said another way, fill yarn 206 can run weftwise in successive, uninterrupted courses back and forth across the fabric, as shown.

Similarly, a filling yarn 208 may be included as well. For example, in an embodiment, fill yarn 208 can be used in border segments of the artificial leather material 100, 110 to provide a stronger structure for supporting attachment to furniture products, as discussed above. Fill yarn 208 can be a 2 ply about 150 denier polyester yarn in an aspect. In an aspect, the fill yarn 208 is an about 840 denier polypropylene yarn. The filling yarn 208 can be continuously incorporated into the knit 200. Said another way, fill yarn 208 can run weftwise in successive, uninterrupted courses back and forth across the fabric, as shown. In an aspect, warp knit elastomeric fabric 200 includes a plurality of elastomeric inlayed yarns 210 that extends coursewise (e.g., through multiple courses of a single wale). The elastomeric inlayed yarn 210 can facilitate a stronger structure by limiting the coursewise elongation. Elastomeric inlayed yarns 210 can be an elastomeric monofilament in the range of about 50-75 durometers and about 1800-2400 denier. For example, in a particular aspect, the plurality of elastomeric inlayed yarns 210 are 72 durometers. Additionally, the plurality of elastomeric inlayed yarns 210 is 1800 denier.

As will be understood by those skilled in the art, warp knit elastomeric fabric 200 is not intended to limit the scope of a warp knit elastomeric fabric suitable for the elastomeric fabric layer 106. Rather, warp knit elastomeric fabric 200 is included as an illustrative example of a warp knit suitable for use as elastomeric fabric layer 106.

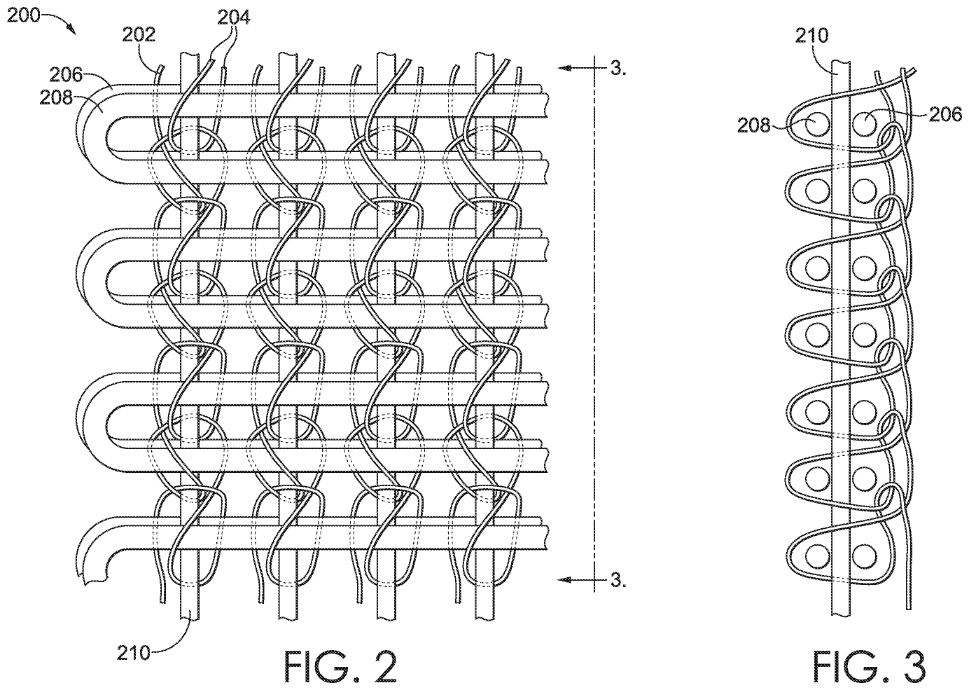

FIG. 3 depicts a side view of the fabric 200 as shown in FIG. 2 along lines 3-3 and likewise shows one example of the filling yarn 208 and fill yarn 206 which runs in successive courses weftwise across, and is held in place by, the stitch-loop chains 202. Additionally, as illustrated, some segments of fabric 200 may include elastomeric inlayed yarn 210 disposed walewise through the stitch-loop chains.

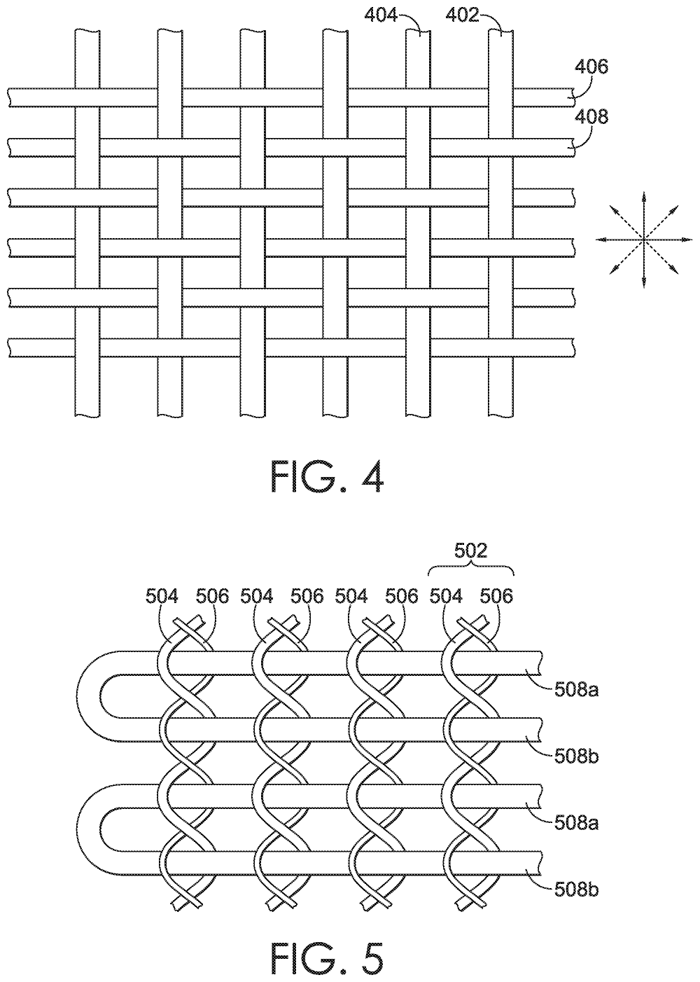

Turning to FIG. 4, an enlarged top-plan view of a section of an elastomeric fabric 400, consistent with some aspects of elastomeric fabric layer 106, is depicted. Plain weave elastomeric fabric 400 comprises a plurality of walewise elastomeric yarns 402, 404 and a plurality of weftwise elastomeric yarns 406, 408. The walewise elastomeric yarns 402, 404 and weftwise elastomeric yarns 406, 408 can be in a range of about 20-25 ends per inch of an elastomeric bi-component monofilament of about 50-75 durometers and about 1800-2400 denier.

As shown, the walewise elastomeric yarn 402 passes over a coarse of weftwise elastomeric yarn 406 and under a coarse of weftwise elastomeric yarn 408. Walewise elastomeric yarn 404 passes under a coarse of weftwise elastomeric yarn 406 and over a coarse of weftwise elastomeric yarn 408. This alternating over-under-over pattern continues for the both the weftwise and walewise elastomeric yarns throughout the plain weave elastomeric fabric 400. This plain weave pattern can create an overall walewise and weftwise lock-down thereby providing a high modulus of elasticity, while simultaneously providing a relative stretch 45° off-axis (e.g., 45° off each of the walewise and weftwise axis). This combination may provide a supportive, durable, and comfortable base layer for some aspects of artificial leather material 100, 110.

Turning to FIG. 5, an enlarged top-plan view of a section of a leno weave elastomeric fabric 500, consistent with some aspects of elastomeric fabric layer 106, is depicted. Leno weave elastomeric fabric 500 comprises a plurality of warp elastomeric yarns 504, 506 and at least one weft elastomeric yarn 508. Each wale 502 of leno weave elastomeric fabric 500 comprises two or more elastomeric yarns, such as warp elastomeric yarns 504 and 506. The weft elastomeric yarn 508 and warp elastomeric yarns 504, 506 can be in a range of about 20-25 ends per inch of an elastomeric bi-component monofilament of about 50-75 durometers and about 1800-2400 denier.

As shown, warp elastomeric yarn 504 alternatively passes under a coarse of a weftwise elastomeric yarn 508a and over the subsequent weftwise elastomeric yarn 508b. Warp elastomeric yarn 506 alternatively passes over a coarse of a weftwise elastomeric yarn 508a and under the subsequent weftwise elastomeric yarn 508b. Concurrently, warp elastomeric yarn 504 alternates positions with warp elastomeric yarn 506 each coarse. Said another way, warp elastomeric yarns 504 and 506 are twisted around each course of the weft elastomeric yarn 508. The weft elastomeric yarn 508 can be continuously incorporated into the elastomeric fabric 500. Said another way, weft elastomeric yarn 508 can run weftwise in successive, uninterrupted courses back and forth across the fabric.

The leno weave elastomeric fabric 500 can create an overall walewise and weftwise lock-down thereby providing a high modulus of elasticity, while simultaneously providing a relative stretch 45° off-axis (e.g., 45° off each of the walewise and weftwise axis). This combination may provide a supportive, durable, and comfortable base layer for some aspects of artificial leather material 100, 110.

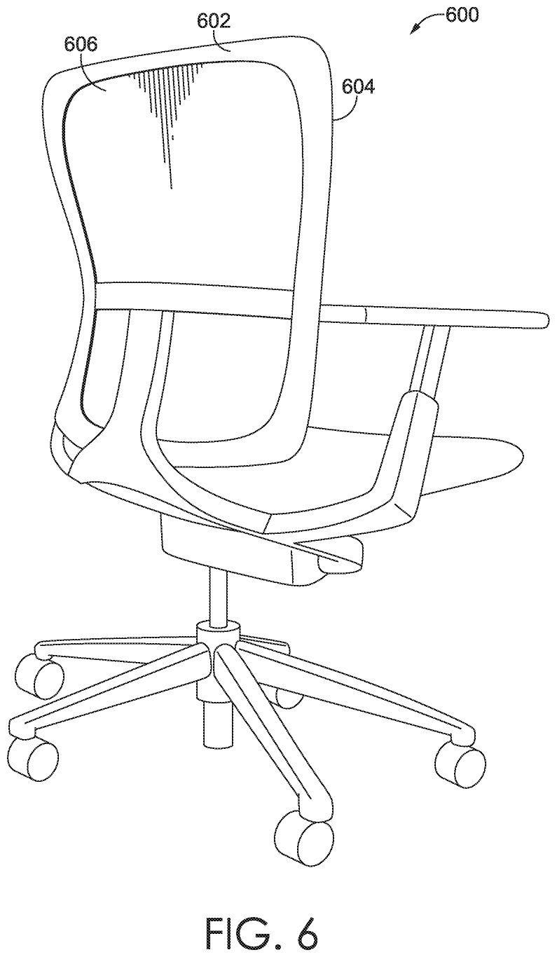

Turning to FIG. 6, an example furniture item 600 including an artificial leather material in accordance with aspects described herein is depicted. Furniture item 600 can be a portion or sub-assembly of a piece of furniture. As shown, furniture item 600 comprises a first portion 602 of the furniture item 600, a second portion 604 of the furniture item 600, and an artificial leather material 606. The first portion 602 and second portion 604 can be attached to artificial leather material 606 using staples, nails, bolts, screws, clamps, or any other attachment mechanisms. In some aspects, artificial leather material 606 can be under tension when attached to the first portion 602 and the second portion 604 to provide a secure and flexible coupling between the two portions of the furniture product thereby providing a seating (or any other contact) surface with a high modulus of elasticity. For example, Table 1 includes test results from selected embodiments after a 100,000 cycle BIFMA fatigue test.

TABLE 1
BIFMA 100,000 Cycle Test-Deflection (in inches)

| | At 50 lbs. Load | | At 100 lbs. Load | | At 150 lbs. Load | | At 200 lbs. Load | |
|---|---|---|---|---|---|---|---|---|
| | Pre-Test | Post-Test | Pre-Test | Post-Test | Pre-Test | Post-Test | Pre-Test | Post-Test |
| Sample ID | Deflection | Deflection | Deflection | Deflection | Deflection | Deflection | Deflection | Deflection |
| Test Sample 1 | 0.8 | 1 | 1.1 | 1.35 | 1.3 | 1.6 | 1.5 | 1.8 |
| Test Sample 2 | 0.7 | 1 | 1.1 | 1.4 | 1.2 | 1.6 | 1.5 | 1.9 |

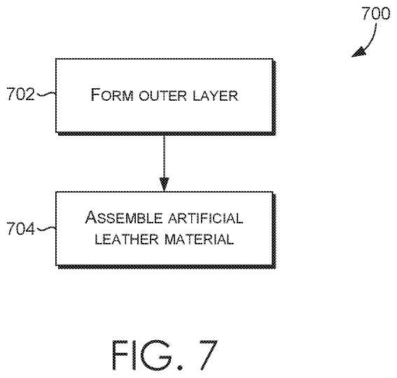

With reference to FIG. 7, an example method 700 for producing an artificial leather material in accordance with aspects described here is depicted. Generally, method 700 is comprised of forming an outer layer and adhering the outer layer to an elastomeric fabric layer. Some aspects of method 700 also include adhering a backing layer to the outer layer, where the backing layer is positioned between the outer layer and the elastomeric fabric. Additionally, method 700 can include adhering a second outer layer, or a second backing layer and a second outer layer, to the elastomeric fabric, thereby disposing the elastomeric fabric between two outer layers. Accordingly, method 700 can be used to create artificial leather materials 100, 110. In turn, the artificial leather materials can be incorporated into one or more portions of a furniture item, such as furniture item 600, with a high modulus of elasticity.

At block 702, an outer layer, such as outer layer 106 as discussed in reference to FIG. 1, is formed. The outer layer can be formed, in some aspects, by dispensing two or more layers of polymer on textured or non-textured paper. As used herein, texture refers to 3-dimensional features intentionally included in the paper to impart patterns in at least the primary sub-layer (e.g., the outer most surface of the outer layer as used in a portion of a furniture product). For example, texture can include grain, stippling, perforations, embossing, or any other aesthetic or functional design feature.

Continuing, the primary sub-layer can be formed by dispensing a PVC plastisol, PE plastisol, or PP plastisol in a range of about 80° C.-160° C. on the textured or non-textured paper. Alternatively, the primary sub-layer of the outer layer can be formed by dispensing a polyurethane resin in a range of about 80° C.-140° C. on the textured or non-textured paper. The use of polyurethane can increase the abrasion resistance of the artificial leather material.

One or more secondary sub-layers of the outer layer can be formed by dispensing a plastisol PVC plastisol, PE plastisol, or PP plastisol in a range of about 80° C.-180° C. on the primary sub-layer. In some aspects, a tertiary sub-layer of the outer layer can be formed by dispensing an acrylic vinyl resin in a range of about 140° C.-160° C. on the secondary sub-layers. The primary, secondary, tertiary, or any combination thereof can also include one or more colorants, one or more additives, or both colorants and additives. In a particular aspect, the PVC plastisol, PE plastisol, or PP plastisol does not include a dioctyl phthalate (DOP) plasticizer. Alternatively, in some aspects the outer layer can be formed of traditional calendered vinyl films.

At block 704, the artificial leather material is assembled. For example, while the final sub-layer (i.e., the last secondary sub-layer, or the tertiary sub-layer) is still in a liquid or gel state, a woven elastomeric fabric, such as plain weave elastomeric fabric 400 of FIG. 4 or leno weave elastomeric fabric 500 of FIG. 5, can be imbedded in the final sub-layer. Once solidified, the outer layer and the woven elastomeric fabric form an artificial leather material with a high modulus of elasticity facilitated by lock-down created by the bi-axial (e.g., walewise and weftwise) elastomeric yarns.

For another example, after an outer layer is solidified an elastomeric fabric with lock-down created by bi-axial (e.g., walewise and weftwise) elastomeric yarns, such as elastomeric fabrics 200 of FIG. 2, elastomeric fabric 400 of FIG. 4, or elastomeric fabric 500 of FIG. 5, can be affixed to the outer layer opposite the primary sub-layer with an adhesive. Although described herein in relation to an artificial leather material, such as from block 704, one skilled in the art will understand that the outer layer may be a woven or knit material in some aspects of method 700.

The adhesive can include a water-based adhesive (such as those available from Stahl™, 3M™, Worthen™, Henkel™, and others), a hot melt polyurethane (PUR) adhesive (such as those available from 3M™, Henkel™, and others), a latex-based adhesive (such as those available from 3M™, Henkel™, Master Bond™, and others), or any other adhesive. Alternatively, a backing, such as backing 104 of FIG. 1, can be affixed to the outer layer opposite the primary sub-layer with an adhesive. The adhesive can include a water-based adhesive, a hot melt PUR adhesive, a latex-based adhesive, or any other adhesive. An elastomeric fabric can be affixed to the backing using adhesive. Once dried, the outer layer and the elastomeric fabric form an artificial leather material with a high modulus of elasticity facilitated by lock-down created by the bi-axial elastomeric yarns. Additionally, in some aspects and using a similar process, another outer layer can be affixed to the elastomeric fabric opposite the previously affixed elastomeric fabric.

Additionally, in some aspects the elastomeric fabric can be affixed to, or imbedded in, the outer layer while under tension. Pre-tensioning the elastomeric fabric may provide a more durable artificial leather material by stretch matching the outer layer and the elastomeric fabric. This can reduce the shear force between the outer layer, backing layer, elastomeric fabric layer, or any combination thereof during repeated load and non-load cycles. Additionally, pre-tensioning the elastomeric fabric can facilitate ensuring the outer layer or backing layer has a functional elongation (e.g., capacity for elongation under load without rupture) greater than or equal to the elastomeric fabric. In other words, pre-tensioning the elastomeric fabric can, in some embodiments, ensure that the outer layer or backing layer can elongate at least as much as the elastomeric fabric layer while under load thereby avoiding splitting, tearing, or rupturing the outer layer or backing layer.

For example, the elastomeric fabric can be tensioned with enough force to elongate the elastomeric fabric in the range of 3%-20%. In some aspects, the elastomeric fabric is tensioned to 12%-15% elongation. In some aspects, the elastomeric fabric is tensioned to 3%-5% elongation. In some aspects, the elastomeric fabric is tensioned to 5%-12% elongation.

The term “about” is used herein in relation to dimensional properties and accounts for variations in manufacturing tolerances. As such, about is used synonymously with ±10% of the relevant quantity in the relevant unit.

The subject matter of the technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of the methods employed, the terms should not be interpreted as implying any particular order among or between various steps herein disclosed unless and except when the order of individual steps is explicitly described.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

As used herein and in connection with the clauses listed hereinafter, the terminology “any of clauses” or similar variations of said terminology is intended to be interpreted such that features of claims/clauses may be combined in any combination. For example, an exemplary clause 4 may indicate the method/apparatus of any of clauses 1 through 3, which is intended to be interpreted such that features of clause 1 and clause 4 may be combined, elements of clause 2 and clause 4 may be combined, elements of clause 3 and 4 may be combined, elements of clauses 1, 2, and 4 may be combined, elements of clauses 2, 3, and 4 may be combined, elements of clauses 1, 2, 3, and 4 may be combined, and/or other variations. Further, the terminology “any of clauses” or similar variations of said terminology is intended to include “any one of clauses” or other variations of such terminology, as indicated by some of the examples provided above.

Clause 1. A multilayer elastomeric material comprising: an outer polyurethane layer; a plastisol layer adjacent the outer polyurethane layer; a first adhesive layer; and an elastomeric fabric.

Clause 2. The multilayer elastomeric material of clause 1, wherein the multilayer elastomeric material further comprises a non-woven reinforcing layer adjacent the plastisol layer and the adhesive layer.

Clause 3. The multilayer elastomeric material of clauses 1 or 2, wherein the multilayer elastomeric material further comprises: a second adhesive layer adjacent the elastomeric fabric and opposite the first adhesive layer; and another outer polyurethane layer.

Clause 4. The multilayer elastomeric material of any of clauses 1 through 3, wherein the adhesive layer comprises a thermoplastic adhesive, a water based latex adhesive, or a low melt polyurethane adhesive.

Clause 5. The multilayer elastomeric material of any of clauses 1 through 4, wherein the elastomeric fabric is comprised of a co-polyester monofilament.

Clause 6. The multilayer elastomeric material of clause 5, wherein the co-polyester monofilament has a diameter in the range of 0.35 mm and 0.55 mm.

Clause 7. The multilayer elastomeric material of clauses 5 or 6, wherein the elastomeric fabric is comprised of a warp knit of the co-polyester monofilament.

Clause 8. The multilayer elastomeric material of clause 7, wherein the warp knit has 10-14 ends per inch.

Clause 9. The multilayer elastomeric material of clauses 5 or 6, wherein the elastomeric fabric is comprised of a plain weave of the co-polyester monofilament.

Clause 10. The multilayer elastomeric material of clause 9, wherein the plain weave has 20-24 ends per inch.

Clause 11. The multilayer elastomeric material of any of clauses 5 through 10, wherein the co-polyester monofilament is between 50 and 80 durometer.

Clause 12. The multilayer elastomeric material of any of clauses 5 through 11, wherein the co-polyester monofilament has a linear density of between 1700 and 1900 denier.

Clause 13. A method for manufacturing a multilayer elastomeric material comprising: applying a liquid polyurethane to a form to form an outer polyurethane layer, wherein the liquid polyurethane is at a temperature between 70° C. and 150° C. when applied to the form; applying a plastisol at a temperature between 140° C. and 160° C. to the outer polyurethane layer; applying an adhesive at a temperature between 90° C. and 110° C. to the plastisol; and applying an elastomeric fabric to the adhesive.

Clause 14. The method of clause 13, wherein the form is comprised of a textured or non-textured paper.

Clause 15. The method of clauses 13 or 14, wherein the functional elongation of the tensioned elastomeric fabric is between 3%-20% elongation.

Clause 16. The method of any of clauses 13 through 15, wherein the elastomeric fabric is comprised of a plurality of elastomeric yarns in a plain weave, leno weave, or warp knit configuration.

Clause 17. The method of clause 16, wherein the warp knit is comprised of walewise parallel stitch-loop chains of a polymeric yarn.

Clause 18. The method of clause 17, wherein the polymeric yarn is formed from about 150 denier, 3 ply, about 68 filament yarn.

Clause 19. The method of clause 17, wherein the warp knit is further comprised of a coursewise inlayed elastomeric monofilament in a range of about 50-75 durometers and about 1800-2400 denier.

Clause 20. The method of clause 16, wherein the plain weave or leno weave is comprised of elastomeric bi-component monofilament warp and weft yarns in a range of about 20-25 ends per inch, about 50-75 durometers, and about 1800-2400 denier.

Clause 21. A multilayer elastomeric material comprising: an upholstery cover material, an adhesive layer, and an elastomeric support.

Clause 22. The multilayer elastomeric material of clause 21, wherein the upholstery cover material is a knit fabric, a woven fabric, a calendered vinyl film, or a cast plastisol vinyl film.

Clause 23. The multilayer elastomeric material of clauses 21 or 22, wherein the adhesive layer is comprised of a water-based natural rubber water dispersion.

Clause 24. The multilayer elastomeric material of clauses 21 or 22, wherein the adhesive layer is comprised of a water-based acrylic latex.

Clause 25. The multilayer elastomeric material of clauses 21 or 22, where the adhesive layer is comprised of a thermoplastic adhesive.

Clause 26. The multilayer elastomeric material of any clauses 21 through 25, wherein the elastomeric support is a biaxially oriented extrusion of a polyester copolymer.

Clause 27. The multilayer elastomeric material of any clauses 21 through 26, wherein the elastomeric support is a warp fabric comprised of 7 to 12 ends per inch of a 55 to 75 co-polyester monofilament.

Clause 28. The multilayer elastomeric material of any clauses 21 through 26, wherein the elastomeric support is a woven fabric comprised of 10 to 25 ends per inch of a 55 to 75 durometer co-polyester monofilament.

Clause 29. The multilayer elastomeric material of any clauses 21 through 26, wherein the elastomeric support is a woven fabric comprised of 10 to 25 ends per inch of a bi-component 55 to 75 durometer co-polyester monofilament.

Clause 30. The multilayer elastomeric material of any clauses 21 through 29, wherein the upholstery cover material has a functional elongation equal to or higher than the elastomeric support.

We claim:

1. A multilayer elastomeric material comprising:
an outer polyurethane layer;
a plastisol layer adjacent the outer polyurethane layer;
a first adhesive layer; and
an elastomeric fabric.

2. The multilayer elastomeric material of claim 1, wherein the multilayer elastomeric material further comprises a non-woven reinforcing layer adjacent the plastisol layer and the adhesive layer.

3. The multilayer elastomeric material of claim 1, wherein the multilayer elastomeric material further comprises:
a second adhesive layer adjacent the elastomeric fabric and opposite the first adhesive layer;
and another outer polyurethane layer.

4. The multilayer elastomeric material of claim 1, wherein the adhesive layer comprises a thermoplastic adhesive, a water reactive adhesive, or a low melt polyurethane adhesive.

5. The multilayer elastomeric material of claim 1, wherein the elastomeric fabric is comprised of a co-polyester monofilament.

6. The multilayer elastomeric material of claim 5, wherein the co-polyester monofilament has a diameter in the range of 0.35 mm and 0.55 mm.

7. The multilayer elastomeric material of claim 5, wherein the elastomeric fabric is comprised of a warp knit of the co-polyester monofilament.

8. The multilayer elastomeric material of claim 7, wherein the warp knit has 10-14 ends per inch.

9. The multilayer elastomeric material of claim 5, wherein the elastomeric fabric is comprised of a plain weave of the co-polyester monofilament.

10. The multilayer elastomeric material of claim 9, wherein the plain weave has 20-24 ends per inch.

11. The multilayer elastomeric material of claim 9, wherein the co-polyester monofilament is between 50 and 80 durometers.

12. The multilayer elastomeric material of claim 9, wherein the co-polyester monofilament has a density of between 1700 and 1900 denier.

13. A method for manufacturing a multilayer elastomeric material comprising:
applying a liquid polyurethane to a form to form an outer polyurethane layer, wherein the liquid polyurethane is at a temperature between 70° C. and 150° C. when applied to the form;
applying a plastisol at a temperature between 140° C. and 160° C. to the outer polyurethane layer;
applying an adhesive at a temperature between 90° C. and 110° C. to the plastisol; and
applying a tensioned elastomeric fabric to the adhesive.

14. The method of claim 13, wherein the form is comprised of a textured or non-textured paper.

15. The method of claim 13, wherein a tension of the tensioned elastomeric fabric is between 10%-20% elongation.

16. The method of claim 13, wherein the elastomeric fabric is comprised of a plurality of elastomeric yarns in a plain weave, leno weave, or warp knit configuration.

17. The method of claim 16, wherein the warp knit is comprised of walewise parallel stitch-loop chains of a polymeric yarn.

18. The method of claim 17, wherein the polymeric yarn is formed from about 150 denier, 3 ply, about 68 filament yarn.

19. The method of claim 17, wherein the warp knit is further comprised of a coursewise inlayed elastomeric monofilament in a range of about 50-75 durometers and about 1800-2400 denier.

20. The method of claim 16, wherein the plain weave or leno weave is comprised of elastomeric bi-component monofilament warp and weft yarns in a range of about 20-25 ends per inch, about 50-75 durometers, and about 1800-2400 denier.
